(19) United States
(12) Patent Application Publication
(10) Pub. No.: US 2010/0175007 A1
(43) Pub. Date: Jul. 8, 2010

(54) SEMICONDUCTOR STORAGE DEVICE AND CONTROL METHOD FOR A SEMICONDUCTOR STORAGE DEVICE

(75) Inventor: Haruyoshi Ohori, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/652,597

(22) Filed: Jan. 5, 2010

(30) Foreign Application Priority Data
Jan. 7, 2009 (JP) 2009-001509
Jan. 8, 2009 (JP) 2009-002251
Dec. 4, 2009 (JP) 2009-276526

(51) Int. Cl. G06F 3/048; G06F 12/00

(52) U.S. Cl. 715/764; 711/154; 711/E12.001

(57) ABSTRACT

A semiconductor storage device and a control method for a semiconductor storage device that displays information corresponding to stored data on a display unit can assure the accuracy of the information displayed on the display unit. A USB memory device 1 that has a storage unit 21 that stores data, and can be removably installed to a personal computer 2 through a connection enabling communication with the personal computer 2, has a display unit 9 for displaying information, and a control unit 17 that controls the display content of the display unit 9 according to the process applied to the storage unit 21.

### BACKGROUND

1. Technical Field

The present invention relates to a semiconductor storage device that is removably connected to an external device, and to a control method for the semiconductor storage device.

2. Related Art

Memory cards that have a display means and display information related to data stored in internal memory on the display means are known from the literature. See, for example, Japanese Unexamined Patent Appl. Pub. JP-A-2007-140677. The memory card taught in JP-A-2007-140677 is used installed by the user to a card slot disposed in the external device.

A problem with memory cards that have a display means and display information based on the data stored in memory on the display means as taught in JP-A-2007-140677 is that when certain processes are executed using the memory, the information displayed by the display means and the data stored in memory may cease to correspond, and the reliability of the information displayed on the display means becomes questionable.

### SUMMARY

A semiconductor storage device and a control method for a semiconductor storage device according to the present invention displays information corresponding to stored data on a display unit, and can assure the accuracy of the information displayed by the display unit.

A first aspect of the invention is a semiconductor storage device that has a storage unit for storing data, can be removably installed to an external device, and can communicate with the external device when installed to the external device, the semiconductor storage device having a display unit that displays information, and a display control unit that controls the content displayed on the display unit according to a process applied to the storage unit.

Because the display content of the display unit is thus controlled according to the process applied to the storage unit, the display content of the display unit reflects the process applied to the storage unit, and the accuracy of the information displayed on the display unit can be assured.

Preferably, the display unit displays information related to data stored in a specific storage area of the storage unit, and the display control unit controls the display unit to display information related to the data stored in the specific storage area when a process is applied to the specific storage area.

In a semiconductor storage device that displays information related to data stored in a specific storage area on the display unit, this aspect of the invention controls the display unit to display information related to the data stored in the specific storage area when a process is executed on the specific storage area. As a result, the information displayed by the display unit is information corresponding to the process applied to the specific storage area, and the accuracy of the information displayed on the display unit can be assured.

In a semiconductor storage device according to another aspect of the invention the display control unit controls the display unit to display information related to the data stored in the specific storage area when a process that includes any one of the operations of overwriting or erasing data stored in the specific storage area, or writing new data to the specific storage area, is executed.

In this aspect of the invention, when a process that includes any one of the operations of overwriting or erasing data stored in the specific storage area, or writing new data to the specific storage area, is executed, the information displayed by the display unit is information corresponding to the process, and the accuracy of the information displayed on the display unit can be assured.

In a semiconductor storage device according to another aspect of the invention the display control unit stops displaying information related to the data stored in the specific storage area on the display unit when a process is executed on the specific storage area.

When the process applied to the specific storage area results in the data stored in the specific storage area not corresponding to the information displayed on the display unit, this aspect of the invention stops displaying the information on the display unit, and the accuracy of the information displayed on the display unit can therefore be assured.

In a semiconductor storage device according to another aspect of the invention the display unit displays information indicating a provider of the data as the information related to the data stored in the specific storage area, and the display control unit stops displaying the information indicating the provider on the display unit when a process is executed on the specific storage area.

The provider is any entity that stores data to the semiconductor storage device and then provides the semiconductor storage device with the stored data to a user, and may be an individual or a corporation. The semiconductor storage device may be provided for free or for compensation. One example of a provider is a manufacturer that manufactures and sells semiconductor storage device storing data.

Because this aspect of the invention stops displaying information identifying the data provider on the display unit when the data becomes untrustworthy as a result of a process being executed on the specific storage area, a loss of trust in the data provider can be prevented.

In a semiconductor storage device according to another aspect of the invention the display control unit displays information related to the executed operation on the display unit when an operation using data stored in the storage unit is executed by an external device that is communicably connected.

Because information related to the executed operation is displayed on the display unit in this aspect of the invention when an operation using data stored in the storage unit is executed by an external device, the user can easily and reliably know about the operation by reading the information presented on the display unit, and user convenience is improved.

In a semiconductor storage device according to another aspect of the invention the display control unit displays information indicating the content of the operation on the display unit when an operation using data stored in the storage unit is executed by an external device.

Because information indicating the content of the operation is displayed on the display unit in this aspect of the invention when an operation using data stored in the storage unit is executed by an external device, the user can easily and reliably know about the content of the operation by reading the information presented on the display unit, and user convenience is improved.

In a semiconductor storage device according to another aspect of the invention the display control unit displays information indicating contact information for queries related to the operation on the display unit when an operation using data stored in the storage unit is executed by an external device.

Because information indicating contact information for queries related to the operation is displayed on the display unit in this aspect of the invention when an operation using data stored in the storage unit is executed by an external device, the user can easily and reliably know the contact information by reading the information presented on the display unit, and user convenience is improved.

In a semiconductor storage device according to another aspect of the invention the display control unit displays information indicating whether or not a user registration required to execute the operation has been completed on the display unit when an operation using data stored in the storage unit is executed by an external device.

Because information indicating whether or not a user registration required to execute the operation has been completed is displayed on the display unit in this aspect of the invention when an operation using data stored in the storage unit is executed by an external device, the user can easily and reliably know if the user registration has been completed by reading the information presented on the display unit. The user can then appropriately complete the process, such as completing the user registration, as a result of this information, and user convenience is improved.

In a semiconductor storage device according to another aspect of the invention, when an operation related to copying data for which an allowed number of copies is set, or an operation related to installing data for which an allowed number of installations is set, is executed by an external device, the display control unit displays information indicating the allowed number of copies or the allowed number of installations on the display unit.

In this aspect of the invention an allowed number of copies is set, or an operation related to installing data for which an allowed number of installations is set, is executed by an external device, information indicating the allowed number of copies or the allowed number of installations is displayed on the display unit. The user can therefore easily and reliably know how many copies can be made or how many installations can be completed by reading the information presented on the display unit, and user convenience is improved.

Another aspect of the invention is a control method for a semiconductor storage device that has a storage unit for storing data, can be removably installed to an external device, and can communicate with the external device when installed to the external device, the control method including steps of displaying information on a display unit disposed to the semiconductor storage device, and controlling the content displayed on the display unit according to a process applied to the storage unit.

Because the display content of the display unit is thus controlled by the control method according to this aspect of the invention according to the process applied to the storage unit, the display content of the display unit reflects the process applied to the storage unit, and the accuracy of the information displayed on the display unit can be assured.

A control method for a semiconductor storage device according to another aspect of the invention has steps of displaying information related to data stored in a specific storage area of the storage unit on the display unit and controlling the display unit to display information related to the data stored in the specific storage area when a process is applied to the specific storage area.

In a semiconductor storage device that displays information related to data stored in a specific storage area on the display unit, the control method according to this aspect of the invention controls the display unit to display information related to the data stored in the specific storage area when a process is executed on the specific storage area. As a result, the information displayed by the display unit is information corresponding to the process applied to the specific storage area, and the accuracy of the information displayed on the display unit can be assured.

In a control method for a semiconductor storage device according to another aspect of the invention, information is displayed on the display unit, and when an operation using data stored in the storage unit is executed by an external device that is communicably connected, infoiination related to the executed operation is displayed on the display unit.

When an operation using data stored in the storage unit is executed by an external device, the control method according to this aspect of the invention displays information about the operation on the display unit. The user can therefore easily and reliably get information about the operation by reading the information displayed on the display unit, and user convenience is improved.

### EFFECT OF THE INVENTION

The accuracy of information displayed on the display unit can be assured in a semiconductor storage device according to this embodiment of the invention that displays information according to stored data on a display unit.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows an example of a USB memory device according to a first embodiment of the invention.

FIG. 2 is a block diagram of the configuration of the USB memory device and a personal computer.

FIG. 3 schematically describes the configuration of the storage unit.

FIG. 4 is a flow chart describing the operation of the USB memory device.

FIG. 5 is a flow chart describing the operation of a USB memory device according to a second embodiment of the invention.

FIG. 6 shows an example of information displayed on the display unit of the USB memory device.

FIG. 7 shows other examples of information displayed on the display unit of the USB memory device according to other embodiments of the invention.

### DESCRIPTION OF EMBODIMENTS

Preferred embodiments of the present invention are described below with reference to the accompanying figures.

### Embodiment 1

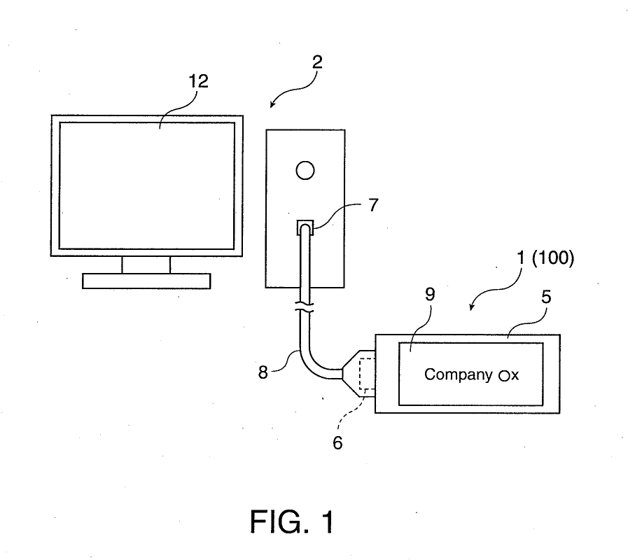

FIG. 1 shows an example of a USB memory device 1 according to a preferred embodiment of a semiconductor storage device according to the invention.

The USB memory device 1 uses flash memory, which is a type of nonvolatile semiconductor memory, and stores data rewritably in the flash memory. The USB memory device 1 can be freely connected to and disconnected from a personal computer 2 (external device). When installed to the personal computer 2, the USB memory device 1 can communicate with the personal computer 2 using the USB (Universal Serial Bus) standard, and can be easily transported by the user when disconnected from the personal computer 2. Note that the USB is just one serial bus standard, and the specifications of the USB standard are established and managed by the USB Implementers Forum, Inc. USB versions 1.0, 1.1, 2.0, and 3.0 are available.

As shown in FIG. 1, the USB memory device 1 has a case 5 in which the flash memory is housed, and a memory-device-side connector 6 disposed to the case 5. A USB port 7 with a matching external-device-side connector (not shown in the figure) is disposed to the personal computer 2. When the USB memory device 1 is installed to the personal computer 2, the memory-device-side connector 6 of the USB memory device 1 is connected directly to the external-device-side connector of the USB port 7, or the memory-device-side connector 6 of the USB memory device 1 is connected to the USB port 7 through an extension cable 8, for example.

A display unit 9 for displaying information is disposed to the surface of the case 5 of the USB memory device 1. As shown in FIG. 1, the information displayed on the display unit 9 can be read when the USB memory device 1 is installed to the personal computer 2.

The USB memory device 1 according to this embodiment of the invention is provided as described below to a user by a provider, and can be used by the user to whom the USB memory device 1 was provided as described below.

The USB memory device 1 may be preloaded by the provider with software programs written for specific purposes (referred to below as “task-specific data”), such as antivirus software for removing computer viruses, file management software, or game software, and then provided to the user by the provider. When the USB memory device 1 is provided to the user, information identifying the provider (“Company Ox” in FIG. 1) is displayed on the display unit 9, and the user can know the provider of the USB memory device 1 by simply referring to the information displayed on the display unit 9.

The user to whom the USB memory device 1 was provided then installs the USB memory device 1 to the personal computer 2, and the personal computer 2 runs the software associated with the task-specific data stored on the USB memory device 1, installs the software on the personal computer 2, or copies the data associated with the software, for example. When the user finishes using the software stored on the USB memory device 1 and will not use the software at a later date, the user can use the personal computer 2 to delete the task-specific data from the USB memory device 1, thus increasing the data storage capacity of the USB memory device 1, and the USB memory device 1 can be used as a general purpose auxiliary storage device.

The provider is any person that stores task-specific data to the USB memory device 1 and then provides the USB memory device 1 with the stored data to a user, and may be an individual or a corporation. The USB memory device 1 may be provided for free or for compensation. One example of a provider is a manufacturer that manufactures and sells USB memory devices 1 storing task-specific data.

The information identifying the provider may be information indicating the name of the provider, information representing a logo associated with the provider, or any other desirable information related to the provider.

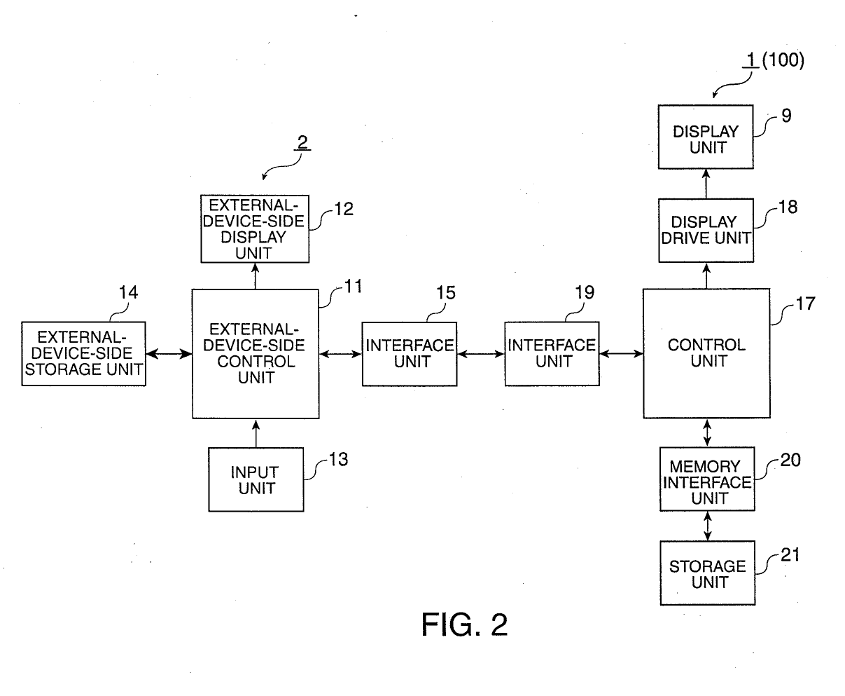

FIG. 2 is a block diagram showing the functional configuration of the USB memory device 1 and the personal computer 2.

As shown in FIG. 2, the personal computer 2 has an external-device-side control unit 11, an external-device-side display unit 12, an input unit 13, an external-device-side storage unit 14, and an external-device-side interface unit 15.

The external-device-side control unit 11 centrally controls the various parts of the personal computer 2, and includes a CPU as the operating unit, a basic control program that is executed by the CPU, ROM for statically storing data associated with the basic control program, programs executed by the CPU, RAM for dynamically storing data associated with those programs, and other peripheral circuit devices.

The external-device-side display unit 12 is rendered using a liquid crystal display panel, and displays information as controlled by the external-device-side control unit 11. Note that the external-device-side display unit 12 is not limited to an LCD panel, and an organic electroluminescent panel, CRT, or other type of display device may be used.

The input unit 13 is connected to a keyboard, mouse, or other type of input device, detects operation of the input device by the user, and outputs operating signals corresponding to the detected operations to the external device.

The external-device-side storage unit 14 is a storage device that uses, for example, magnetic or optical storage media, or semiconductor storage devices, and stores various types of information.

The external-device-side interface unit 15 communicates with the USB memory device 1 according to the USB standard as controlled by the external-device-side control unit 11.

As also shown in FIG. 2, the USB memory device 1 has a control unit 17, a display unit 9, a display drive unit 18, an interface unit 19, a memory interface unit 20, and a storage unit 21.

The control unit 17 centrally controls the various parts of the USB memory device 1, and similarly to the personal computer 2 includes a CPU as the operating unit, a basic control program that is executed by the CPU, ROM for statically storing data associated with the basic control program, programs executed by the CPU, RAM for dynamically storing data associated with those programs, and other peripheral circuit devices.

The display unit 9 displays information as controlled by the control unit 17, and in this embodiment of the invention is rendered using electronic paper that displays information using a microcapsule-type electrophoretic display. Electronic paper that presents information using a microcapsule-type electrophoretic display is extremely thin, enables changing the information that is displayed, and can continue displaying the information when power is not supplied thereto.

Because electronic paper can thus be manufactured extremely thin, a smaller USB memory device 1 can be rendered using electronic paper than when the display unit 9 is disposed with the area of the display unit 9 in the case 5 protruding from the surrounding area, and a smaller size makes it easier for the USB memory device 1 to be transported by the user.

Furthermore, because electronic paper enables changing the displayed information, the displayed information can be changed according to the data stored in the USB memory device 1, for example, the user can easily and reliably check the data stored in the USB memory device 1, and user convenience is thus improved.

Furthermore, because electronic paper can continue displaying the information when power is not supplied thereto, the information can be displayed not only when the USB memory device 1 is connected to the personal computer 2 and receives power supplied from the personal computer 2, but also when the USB memory device 1 is disconnected from the personal computer 2. The user can therefore check the data stored in the USB memory device 1 after the USB memory device 1 has been disconnected from the personal computer 2 by referring to the information displayed on the display unit 9 of the USB memory device 1. As a result, user convenience is improved because it is not necessary to connect the USB memory device 1 to a personal computer 2 in order to check the data stored on the USB memory device 1.

Note that the display unit 9 is also not limited to electronic paper that displays information using a microcapsule-type electrophoretic display method, and may be rendered using electronic paper that uses cholesteric liquid crystals or other type of liquid crystal, electronic paper that uses organic electroluminescence, and electronic paper that displays information using display methods such as twisting ball, thermal rewritable, toner display, and electrophoretic particle methods.

The display drive unit 18 is a circuit that drives the electronic paper of the display unit 9, and supplies drive signals to the electronic paper of the display unit 9 and displays information on the display unit 9 as controlled by the control unit 17.

The interface unit 19 communicates with the personal computer 2 using the USB standard as controlled by the control unit 17.

The memory interface unit 20 executes interface processes enabling communication between the control unit 17 and the storage unit 21.

The storage unit 21 is rendered by flash memory and stores data, such as data related to software written for a specific task as described above.

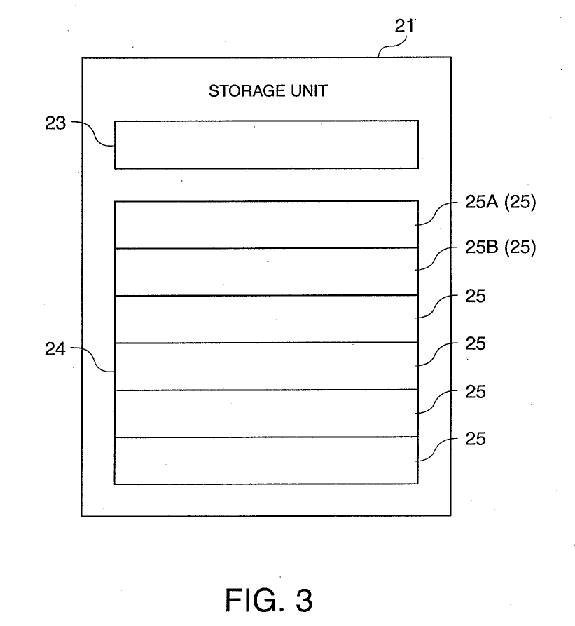

FIG. 3 schematically describes the configuration of the storage area of the storage unit 21.

As shown in FIG. 3, the storage unit 21 has two storage areas, a non-rewritable storage area 23 and a rewritable storage area 24.

The non-rewritable storage area 23 is a storage area where data that cannot be accessed and processed by the user is stored, including the flash memory control program and other data related to information for controlling the storage unit 21, data for managing the storage area of the flash memory, and data indicating locations in the storage areas formed in the flash memory.

The rewritable storage area 24 is a storage area for storing data that can be read, overwritten, erased, and written according to user instructions input to the personal computer 2 when the USB memory device 1 is installed to the personal computer 2. As shown in FIG. 3, the storage area of the rewritable storage area 24 is segmented into blocks 25, and erasing data stored in the rewritable storage area 24 is done by block 25 unit. Each block 25 is divided into pages, and data is read and written by page unit.

The task-specific data is stored in a specific area in this rewritable storage area 24 by the provider. More specifically, task-specific data is stored in blocks 25A and 25B of the rewritable storage area 24 in this embodiment of the invention.

When the content of the task-specific data pre-stored in the USB memory device 1 changes, such as when new data is stored after the user deletes the task-specific data, the data stored in the USB memory device 1 will no longer be the same as the data that was produced and stored by the provider to be provided to the user, and the content of which was therefore known to the provider. Therefore, if the information indicating the provider continues to be displayed on the display unit 9 after the content of the data is changed, the data displayed on the display unit 9 will not correspond to the actual data content, and the accuracy of the data displayed on the display unit 9 will be questionable. The USB memory device 1 according to this embodiment of the invention therefore assures the accuracy of the information displayed on the display unit 9 by executing the operation described below.

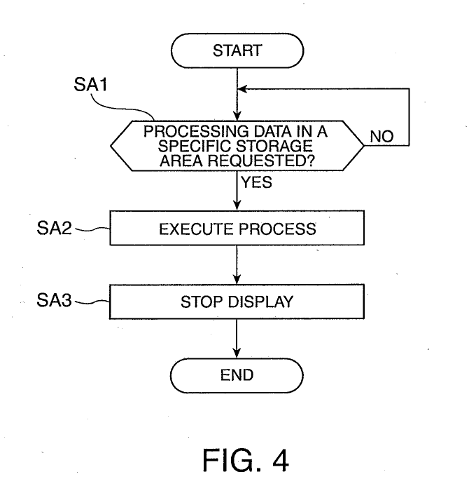

FIG. 4 is a flow chart describing the operation of the USB memory device 1. During the operation shown in this flow chart, the control unit 17 functions as the display control unit.

Note that in the operation described below the USB memory device 1 is connected to the personal computer 2, and the user can operate an input device of the personal computer 2 and cause the personal computer 2 to execute processes based on the data stored in the USB memory device 1.

Further note that when the process shown in the flow chart starts, the USB memory device 1 is in the same condition as when provided to the user by the provider, that is, the task-specific data is stored and the information indicating the provider is displayed on the display unit 9.

The control unit 17 of the USB memory device 1 monitors if a command has been received to start processing the blocks 25 of the rewritable storage area 24 where the task-specific data is stored, that is, blocks 25A, 25B in this embodiment of the invention (step SA1). Note that processing blocks 25A, 25B here includes any operation that overwrites or erases data stored in blocks 25A and 25B, or writes new data to blocks 25A, 25B. These processes are specified by the user using an input device of the personal computer 2, and the personal computer 2 outputs a corresponding signal to the USB memory device 1. When a process that includes any one of the operations of overwriting or erasing data stored in the blocks 25A, 25B storing the task-specific data, or writing new data to these blocks 25A, 25B, is executed, there is a strong possibility that the content of the task-specific data is changed.

When a command starting processing blocks 25A, 25B is asserted (step SA1 returns Yes), the control unit 17 controls the storage unit 21 and executes the specified process (step SA2). The control unit 17 then controls the display drive unit 18 and stops displaying the information indicating the provider displayed on the display unit 9 (step SA3).

When a process that includes any one of the operations of overwriting or erasing data stored in the blocks 25A, 25B storing the task-specific data, or writing new data to these blocks 25A, 25B, is executed in this embodiment of the invention, the control unit 17 thus controls the information displayed on the display unit 9 and stops displaying the information indicating the provider on the display unit 9. More specifically, when the likelihood is high that there was a change in the content of the task-specific data stored in the blocks 25A, 25B, the information indicating the provider that is displayed on the display unit 9 is automatically erased. As a result, when there is a change in the content of the task-specific data, the data stored in the USB memory device changes to data that differs from the data stored by the provider, and the data stored in the USB memory device 1 no longer corresponds to the provider data, continuing to display the information indicating the provider on the display unit 9 is prevented, and the accuracy of the information displayed on the display unit 9 can be assured.

Note that when the data stored in blocks 25A, 25B is processed in this embodiment of the invention, the control unit 17 stops displaying the information indicating the provider on the display unit 9, but the operation of the control unit 17 when data in the blocks 25A, 25B is processed is not so limited. For example, when blocks 25A, 25B are processed, the control unit 17 could cause information indicating that the content of the task-specific data changed, or information indicating that the reliability of the data stored in the USB memory device 1 is low, to be displayed instead of the information indicating the provider. More specifically, when blocks 25A, 25B are processed, the control unit 17 causes information related to the executed process to be displayed. This operation also has the effect of assuring the accuracy of the information displayed on the display unit 9.

By executing an operation such as described using the flow chart in FIG. 4, the USB memory device 1 according to this embodiment of the invention also has the following effect.

More specifically, the USB memory device 1 is provided to the user with information indicating the provider displayed on the display unit 9 after the task-specific data is stored. The user can thus know that the provider displayed on the display unit 9 created the task-specific data, and can trust that the reliability of the task-specific data is assured.

The task-specific data can also be maliciously modified by the user or some other third party. For example, data related to a program containing the task-specific data could be modified so that an operating error occurs when an operation based on the task-specific data is executed by the personal computer 2, or data related to a computer virus could be added to the data.

In this situation, when another user executes a process on the personal computer 2 based on the modified data, an operating error will occur in the personal computer 2 or the personal computer 2 may be infected with a virus, and damage can thus be inflicted on another user. If information indicating the provider is displayed on the display unit 9 in this situation, trust in the provider will be lost because the user will think that the provider shown on the display unit 9 created the data and therefore believe that the data is reliable.

However, this embodiment of the invention erases information indicating the provider displayed on the display unit 9 when a process that includes any one of the operations of overwriting or erasing the task-specific data stored in the blocks 25A, 25B, or writing new data to these blocks 25A, 25B, is executed. More specifically, when the task-specific data could have been maliciously modified by the user or other third party, displaying information indicating the original provider on the display unit 9 is automatically and reliably stopped. A loss of trust in the provider by other users can thus be prevented.

More particularly, when any process affecting blocks 25A or 25B is executed, this embodiment of the invention stops displaying information indicating the provider on the display unit 9 without determining whether or not the executed process could result in harm to the user. Determining if processing blocks 25A, 25B could result in damage to the user as a result of the process is difficult, and if a special program for making this determination is written, the development period may become longer and the development cost may increase. Therefore, because this embodiment of the invention stops displaying information indicating the provider on the display unit 9 when a process affecting blocks 25A, 25B is executed whether or not the process could result in harm to another user, a loss of trust in the provider can be effectively prevented, and an increase in development time and development cost can be prevented.

As described above, the USB memory device 1 according to this embodiment of the invention has a storage unit 21 with storage areas for storing data, can be removably connected to a personal computer 2, and when installed to a personal computer 2 can communicate with the personal computer 2 using the USB standard. The USB memory device 1 also has a display unit 9 for displaying various information, and a control unit 17 that controls the content displayed on the display unit according to processes applied to the storage unit 21.

As a result, the display content of the display unit 9 reflects the process executed on the storage unit 21, and the accuracy of the information displayed on the display unit 9 can be assured, because the display content of the display unit 9 is controlled according to the process applied to the storage unit 21.

As described above, the USB memory device 1 according to this embodiment of the invention has a storage unit 21 with storage areas for storing data, can be removably connected to a personal computer 2, and when installed to a personal computer 2 can communicate with the personal computer 2 using the USB standard. The USB memory device 1 also has a display unit 9 that displays information indicating the provider, which is also information related to the task-specific data stored in a special block 25A, 25B in the storage area of the rewritable storage area 24, and a control unit 17 that controls the information displayed on the display unit 9 related to the data stored in the blocks 25A, 25B when a process is applied to the blocks 25A, 25B.

Because the information displayed by the display unit 9 is thus controlled when the blocks 25A, 25B are processed, the information displayed on the display unit 9 will be information corresponding to the process, and the accuracy of the information displayed on the display unit 9 can be assured.

Yet further, the control unit 17 in this embodiment of the invention controls the information displayed on the display unit 9 when a process that includes any one of the operations of overwriting or erasing data stored in the blocks 25A, 25B, or writing new data to these blocks 25A, 25B, is executed.

As a result, when a process that includes any one of the operations of overwriting or erasing data stored in the blocks 25A, 25B, or writing new data to these blocks 25A, 25B, is executed, the information displayed on the display unit 9 changes to information corresponding to these operations, and the accuracy of the information displayed on the display unit 9 can be assured.

Furthermore, this embodiment of the invention may also stop displaying information related to the data stored in the blocks 25A, 25B on the display unit 9 when any process is applied to the blocks 25A, 25B.

As a result, because displaying the information related to the data stored in the blocks 25A, 25B is stopped in this embodiment of the invention when the data stored in the blocks 25A, 25B and the information displayed on the display unit 9 cease to correspond as a result of processing the blocks 25A, 25B, the accuracy of the information displayed on the display unit 9 can be assured.

Yet further, the display unit 9 displays information indicating the provider as the information related to the data stored in the blocks 25A, 25B in this embodiment of the invention, and stops displaying the information indicating the provider on the display unit 9 when the blocks 25A, 25B are processed.

As a result, when the data stored in the blocks 25A, 25B becomes unreliable as a result of processing the blocks 25A, 25B, a loss of trust in the provider can be prevented because displaying information that is related to the data and indicates the provider on the display unit 9 is stopped.

As also described above, the USB memory device 1 according to this embodiment of the invention has a case 5 in which the storage unit 21 is held, and the display unit 9 is disposed on the surface of the case 5 so that the information displayed in the display unit 9 can be read when the USB memory device 1 is connected to the personal computer 2.

As a result, the user can check the information displayed by the display unit 9 even when the USB memory device 1 is connected to the personal computer 2. Furthermore, because the information displayed on the display unit 9 is information of which the reliability is assured, the user can reference information that is known to be reliable even when the USB memory device 1 is connected to the personal computer 2 and the data stored on the USB memory device 1 is being used through the personal computer 2, and user convenience is thus improved.

### Embodiment 2

A second embodiment of the invention is described next.

The structural configuration of a USB memory device 100 according to this embodiment of the invention is the same as described in FIG. 1 in the first embodiment above, the functional configuration is the same as shown described in FIG. 2 and FIG. 3 for the first embodiment, and FIG. 1, FIG. 2, and FIG. 3 are used below while omitting further detailed description thereof.

When the USB memory device 100 according to this embodiment of the invention is installed to a personal computer 2, the USB memory device 100 also stores data related to the software that is executed by the personal computer 2 while the USB memory device 100 is installed. This data is, for example, data related to utility software such as antivirus programs and file management programs. The user that owns the USB memory device 100 connects the USB memory device 100 to a personal computer 2 so that the USB memory device 100 and personal computer 2 can communicate with each other, and then installs software stored on the USB memory device 100 in the personal computer 2. This enables the personal computer 2 to execute the installed software.

A personal computer 2 typically simultaneously runs different types of programs, including word processors, spreadsheet programs, media players, and more, and information related to the program being executed is displayed on an external-device-side display unit 12. When the USB memory device 100 is communicably connected to the personal computer 2 in such an environment, and the personal computer 2 executes an operation using data stored in the storage unit 21 of the USB memory device 100, it is difficult for the user to know if the operation using the data stored in the storage unit 21 is actually being executed by the personal computer 2. As a result of the USB memory device 100 executing the operation described below, this embodiment of the invention enables the user to easily and reliably check if the personal computer 2 is actually executing an operation using data stored in the storage unit 21, and thus improves user friendliness.

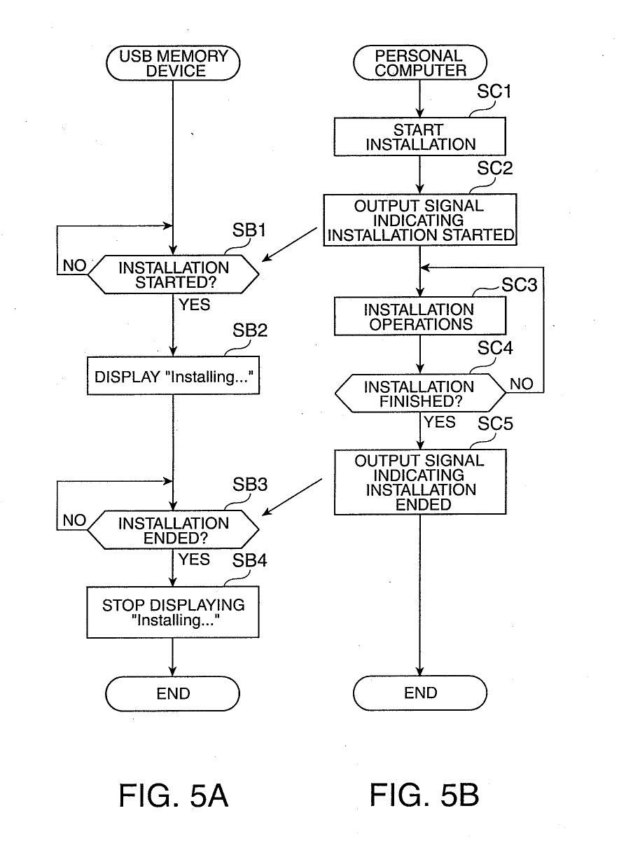

FIG. 5 is a flow chart showing the operation of the USB memory device 100 and the personal computer 2. In FIG. 5 the operation of the USB memory device 100 is shown in (A), and the operation of the personal computer 2 is shown in (B).

Note that when the process shown in FIG. 5 starts, the USB memory device 100 is communicably connected to the personal computer 2, and the user can operate the input unit 13 of the personal computer 2 to cause the personal computer 2 to execute an operation using data stored in the storage unit 21.

Note that a software installation operation is used by way of example in the flow chart shown in FIG. 5 as an operation executed by the personal computer 2 using data stored in the storage unit 21.

A command to start installing software stored on the USB memory device 100 is first input by the user operating an input device of the USB memory device 1 (step SC1).

When this start installation command is asserted, the external-device-side control unit 11 of the personal computer 2 outputs a signal indicating that installation started to the USB memory device 100 (step SC2).

The external-device-side control unit 11 then executes the steps of the installation process, such as starting a dedicated installer script, displaying a user agreement on the external-device-side display unit 12, selecting the device to which the software is to be installed, reading the data required for installation from the USB memory device 100, and processing files, for example (step SC3). The external-device-side control unit 11 executes the installation process until installation is finished (step SC3 and step SC4), and when the installation is completed (step SC4 returns Yes), outputs a signal indicating that installation ended to the USB memory device 100 (step SC5).

The control unit 17 of the USB memory device 100 monitors if an installation process is started by the personal computer 2 (step SB1). When the control unit 17 detects that installation started as a result of a signal indicating that installation started being input from the personal computer 2 (step SB1 returns Yes), the control unit 17 controls the display drive unit 18 to display a message indicating that installation is in progress on the display unit 9 (step SB2).

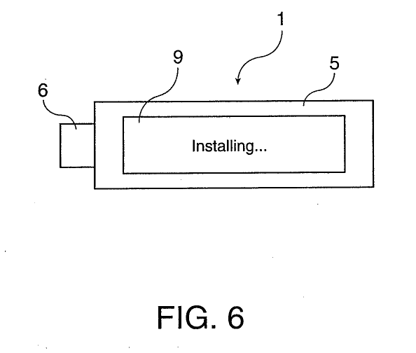

FIG. 6 shows an example of the message presented on the display unit 9 when step SB2 executes.

As shown in FIG. 6, when step SB2 executes, a message indicating that installation is in progress is displayed on the display unit 9 (in the example shown in FIG. 6, “Installing . . . ” is displayed).

As described above, information displayed on the display unit 9 can be read when the USB memory device 100 is connected to the personal computer 2. Therefore, by reading the display unit 9 of the USB memory device 100, the user can easily and reliably know that software stored in the USB memory device 100 is being installed. More specifically, when a plurality of applications are simultaneously open and information relating to plural applications is displayed on the external-device-side display unit 12, the user can easily and reliably know that software stored in the USB memory device 100 is being installed without searching for information indicating that software is being installed on the external-device-side display unit 12, or without operating the input device of the personal computer 2 to specifically display information indicating if software is being installed. User convenience is thus improved. In other words, because information indicating the content of a particular operation is displayed on the display unit 9 of the USB memory device 100 when the personal computer 2 executes an operation using data stored in the storage unit 21 of the USB memory device 100, the user can easily and reliably know the content of the operation, and user convenience is improved.

Referring again to FIG. 5, after a message indicating installation is in progress is presented on the display unit 9 in step SB2, the control unit 17 monitors if installation has ended (step SB3). If completion of the installation is detected by a signal indicating that installation was completed being input from the personal computer 2 (step SB2 returns Yes), the control unit 17 removes the message indicating that software is being installed from the display unit 9 (step SB4).

A software installation process is used in this embodiment as an example of an operation that uses data stored in the storage unit 21, but operations using data stored in the storage unit 21 are not so limited. For example, if data or video data is stored on the USB memory device 100, reproducing such data for listening or viewing by the personal computer 2 is also an operation using data stored in the storage unit 21. In this situation the control unit 17 displays a message indicating that the data is being played on the display unit 9 while the data is reproduced. The invention can thus be applied to all personal computer 2 operations that use data stored in the storage unit 21 of the USB memory device 100.

As described above, the USB memory device 100 according to this embodiment of the invention has a storage unit 21 with storage areas for storing data, can be removably connected to a personal computer 2, and when installed to a personal computer 2 can communicate with the personal computer 2 using the USB standard. The USB memory device 100 also has a display unit 9 for displaying various information, and a control unit 17 that controls the content displayed on the display unit according to processes applied to the storage unit 21.

As a result, the display content of the display unit 9 reflects the process executed on the storage unit 21, and the accuracy of the information displayed on the display unit 9 can be assured, because the display content of the display unit 9 is controlled according to the process applied to the storage unit 21.

The USB memory device 100 according to this embodiment of the invention has a storage unit 21 for storing data, and is communicably connected to the personal computer 2, and the personal computer 2 executes operations using data stored in the storage unit 21. The USB memory device 100 also has a display unit 9 for displaying information, and when the personal computer 2 executes an operation using data stored in the storage unit 21, information related to that operation is displayed on the display unit 9.

As a result, because information related to the executed operation is displayed on the display unit 9 when an operation using data stored in the storage unit 21 is executed by the personal computer 2, the user can easily and reliably check the operation by reading the information presented on the display unit 9, and user convenience is improved.

When the personal computer 2 executes an operation using data stored in the storage unit 21, information describing the content of that operation may also be displayed on the display unit 9 in this embodiment of the invention.

As a result, because information related to the content of the operation is displayed on the display unit 9 when an operation using data stored in the storage unit 21 is executed by the personal computer 2, the user can easily and reliably check the content of the operation by reading the information presented on the display unit 9, and user convenience is improved.

As also described above, the USB memory device 100 according to this embodiment of the invention has a case 5 in which the storage unit 21 is held, and the display unit 9 is disposed on the surface of the case 5 so that the information displayed in the display unit 9 can be read when the USB memory device 1 is connected to the personal computer 2.

As a result, the user can read the information displayed by the display unit 9 even when the USB memory device 100 is connected to the personal computer 2, and user convenience is improved.

### Embodiment 3

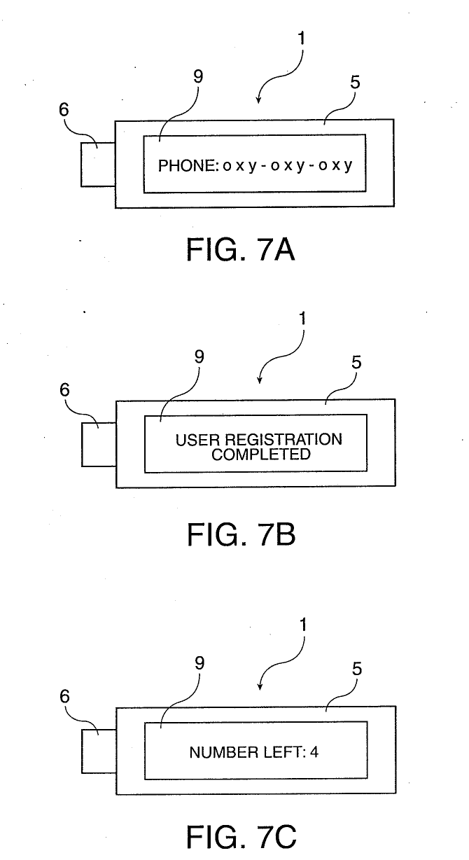

A third embodiment of the invention is described next with reference to FIG. 7A.

FIG. 7A shows an example of the content presented on the display unit 9 of the USB memory device 100 according to this embodiment of the invention.

When an operation using data stored in the storage unit 21 of the USB memory device 100 is executed by the personal computer 2 in this embodiment of the invention, information providing contact information for queries related to the operation is displayed on the display unit 9.

In this example the operation using data stored in the storage unit 21 is the installation of software using that data. When the installation is started by the personal computer 2 and a signal indicating the start of installation is input, the control unit 17 of the USB memory device 100 in this embodiment of the invention displays contact information on the display unit 9 that the user can use to get assistance if a problem occurs during installation, if the installation is not completed normally, or if there are questions regarding using the software after the installation ends, for example. Data denoting this contact information is stored in the storage unit 21 linked to the data associated with the software by the person that stores the software-related data in the storage unit 21.

In the example shown in FIG. 7A, a telephone number (shown as “PHONE: oxy-oxy-oxy” in FIG. 7A) is displayed on the display unit 9 as the contact information. The contact information is obviously not limited to a telephone number, and may be a URL, postal address, or other information.

In this embodiment of the invention, when an operation using data stored in the storage unit 21 is executed by the personal computer 2, information providing contact information for queries related to the operation is displayed on the display unit 9. As a result, the user can reliably obtain contact information related to the operation currently being executed by the personal computer 2 by reading the information displayed on the display unit 9 of the USB memory device 100. Therefore, if the operation executed by the personal computer 2 fails or a problem occurs during the operation, the user can easily and reliably obtain contact information without needing to search the instruction manual for the USB memory device 100 to find the contact information, without needing to use the input device of the personal computer 2 to specifically find and display the contact information on the external-device-side display unit 12, and without needing to search the Internet for the contact information, for example. User convenience is therefore improved.

As described above, when an operation using data stored in the storage unit 21 is executed by the personal computer 2, information providing contact information for queries related to the operation is displayed on the display unit 9 in this embodiment of the invention.

As a result, because information providing contact information for queries related to the operation is displayed on the display unit 9 when an operation using data stored in the storage unit 21 is executed by the personal computer 2, the user can easily and reliably obtain the contact information by reading the information displayed on the display unit 9, and user convenience is improved.

### Embodiment 4

A fourth embodiment of the invention is described next with reference to FIG. 7B.

FIG. 7B shows an example of the content presented on the display unit 9 of the USB memory device 100 according to this embodiment of the invention.

When an operation using data stored in the storage unit 21 of the USB memory device 100 is executed by the personal computer 2 in this embodiment of the invention, information indicating whether or not the user registration required for the installation has been completed is displayed on the display unit 9.

In this example the operation using data stored in the storage unit 21 is the installation of software using that data. When the installation is started by the personal computer 2 and a signal indicating the start of installation is input, the control unit 17 of the USB memory device 100 in this embodiment of the invention displays on the display unit 9 information indicating whether or not the user registration required for installation has been completed. For example, if the signal input from the personal computer 2 includes a signal indicating whether or not the user registration required for installation has been completed, the USB memory device 100 determines based on the input signal if the user registration has been completed, and displays the result on the display unit 9.

Information indicating that the user registration has already been completed (“USER REGISTRATION COMPLETED” is displayed in FIG. 7B) is displayed on the display unit 9 in FIG. 7B.

In this embodiment of the invention, when an operation using data stored in the storage unit 21 is executed by the personal computer 2, information indicating whether or not the user registration required to execute the operation has been completed is displayed on the display unit 9. As a result, the user can easily and reliably check if the user registration required for the operation currently executed by the personal computer 2 has been completed by reading the information displayed on the display unit 9 of the USB memory device 100. Based on this information, the user can quickly execute the necessary process, such as completing the user registration, and user convenience is thus improved.

As described above, when an operation using data stored in the storage unit 21 is executed by the personal computer 2, information indicating whether or not the user registration required to execute the operation has been completed is displayed on the display unit 9.

As a result, because information indicating whether or not the user registration required to execute the operation has been completed is displayed on the display unit 9 when an operation using data stored in the storage unit 21 is executed by the personal computer 2, the user can easily and reliably know if the user registration has been completed by reading the information displayed on the display unit 9. Based on this information, the user can quickly execute the necessary process, such as completing the user registration, and user convenience is thus improved.

### Embodiment 5

A fifth embodiment of the invention is described next with reference to FIG. 7C.

FIG. 7C shows an example of the content presented on the display unit 9 of the USB memory device 100 according to this embodiment of the invention.

In this embodiment of the invention data that can only be copied a predetermined number of times to a personal computer 2 is stored in the USB memory device 100, and each time the personal computer 2 executes an operation related to copying that data, information indicating the remaining number of times the data can be copied is displayed on the display unit 9.

For example, when data that is allowed to be copied only a specified number of times is stored to the storage unit 21 of the USB memory device 100, the control unit 17 stores the data linked to other data that indicates the number of times the stored data can be copied. When an operation that copies the data from the storage unit 21 to the personal computer 2 then starts and a signal indicating that copying started is input, the control unit 17 of the USB memory device 100 reads the data indicating the number of times the data can be copied, and displays that number minus 1 on the display unit 9.

In FIG. 7C information indicating that the remaining number of copies is 4 (“NUMBER LEFT: 4” is displayed in FIG. 7C) is displayed on the display unit 9.

In this embodiment of the invention, when the personal computer 2 executes an operation to copy data that is allowed to be copied to a personal computer 2 only a certain number of times, information indicating the remaining number of copies that can be made is displayed on the display unit 9. As a result, the user can reliably know how many more copies can be made by reading the information displayed on the display unit 9 of the USB memory device 100. The user can thus easily and reliably know how many more copies can be made without using the input device of the personal computer 2 specifically to display how many more copies can be made on the external-device-side display unit 12, and user convenience is thus improved.

Note that while the number of copies that can be made is displayed by way of the example in this embodiment, how many times a software program can be installed may be displayed instead of how many times data can be copied. This configuration has the same effect as described above.

As described above, when the personal computer 2 executes an operation related to copying data for which an allowed number of copies is set, or executes an operation related to installing data for which an allowed number of installations is set, information indicating the number of copies that can be made or the number of times the data can be installed is displayed on the display unit 9 in this embodiment of the invention.

As a result, when an operation related to copying data for which an allowed copy count is set, or an operation related to installing data for which an allowable number of installations is set, is executed by the personal computer 2, information indicating the number of copies that can be made or the number of times the data can be installed is displayed on the display unit 9. The user can thus easily and reliably know how many more copies can be made or how many times the data can be installed by reading the information displayed on the display unit 9, and user convenience is improved.

It will be obvious to one with ordinary skill in the related art that the embodiments described above are merely examples of preferred embodiments of the invention, and can be varied and applied in many ways without departing from the scope of the accompanying claims.

For example, a USB memory device is used as an example of a semiconductor storage device in the foregoing embodiments, but the invention is not limited to a USB memory device and can obviously be applied to a wide range of storage devices that use semiconductor memory, including card-style memory cards.

Furthermore, the USB memory device 1 may store plural different types of task-specific data as the data that is related to software written for specific tasks.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A semiconductor storage device that has a storage unit for storing data, can be removably installed to an external device, and can communicate with the external device when installed to the external device, comprising:
a display unit that displays information; and
a display control unit that controls the content displayed on the display unit according to a process applied to the storage unit.

2. The semiconductor storage device described in claim 1, wherein:
the display unit displays information related to data stored in a specific storage area of the storage unit; and
the display control unit controls the display unit to display information related to the data stored in the specific storage area when a process is applied to the specific storage area.

3. The semiconductor storage device described in claim 2, wherein:
the display control unit controls the display unit to display information related to the data stored in the specific storage area when a process that includes any one of the operations of overwriting or erasing data stored in the specific storage area, or writing new data to the specific storage area, is executed.

4. The semiconductor storage device described in claim 2, wherein:
the display control unit stops displaying information related to the data stored in the specific storage area on the display unit when a process is executed on the specific storage area.

5. The semiconductor storage device described in claim 2, wherein:
the display unit displays information indicating a provider of the data as the information related to the data stored in the specific storage area; and
the display control unit stops displaying the information indicating the provider on the display unit when a process is executed on the specific storage area.

6. The semiconductor storage device described in claim 1, wherein:
the display control unit displays information related to the executed operation on the display unit when an operation using data stored in the storage unit is executed by an external device that is communicably connected.

7. The semiconductor storage device described in claim 6, wherein:
the display control unit displays information indicating the content of the operation on the display unit when an operation using data stored in the storage unit is executed by an external device.

8. The semiconductor storage device described in claim 6, wherein:
the display control unit displays information indicating contact information for queries related to the operation on the display unit when an operation using data stored in the storage unit is executed by an external device.

9. The semiconductor storage device described in claim 6, wherein:
the display control unit displays information indicating whether or not a user registration required to execute the operation has been completed on the display unit when an operation using data stored in the storage unit is executed by an external device.

10. The semiconductor storage device described in claim 6, wherein:
when an operation related to copying data for which an allowed number of copies is set, or an operation related to installing data for which an allowed number of installations is set, is executed by an external device,
the display control unit displays information indicating the allowed number of copies or the allowed number of installations on the display unit.

11. A control method for a semiconductor storage device that has a storage unit for storing data, can be removably installed to an external device, and can communicate with the external device when installed to the external device, the control method comprising steps of:
displaying information on a display unit disposed to the semiconductor storage device; and
controlling the content displayed on the display unit according to a process applied to the storage unit.

12. The control method for a semiconductor storage device described in claim 11, comprising steps of:
displaying information related to data stored in a specific storage area of the storage unit on the display unit; and
controlling the display unit to display information related to the data stored in the specific storage area when a process is applied to the specific storage area.

13. The control method for a semiconductor storage device described in claim 12, wherein:
when a process is executed on the specific storage area, displaying information related to the data stored in the specific storage area on the display unit stops.

14. The control method for a semiconductor storage device described in claim 12, wherein:
information indicating a provider of the data is displayed as the information related to the data stored in the specific storage area; and
when a process is executed on the specific storage area, displaying the information indicating the provider on the display unit stops.

15. The control method for a semiconductor storage device described in claim 11, wherein:
information is displayed on the display unit, and when an operation using data stored in the storage unit is executed by an external device that is communicably connected, information related to the executed operation is displayed on the display unit.
